(19) United States
(12) Patent Application Publication
(10) Pub. No.: US 2002/0176967 A1
(43) Pub. Date: Nov. 28, 2002

(54) Window dressing

(76) Inventor: Vincent R. Fedele, Philadlphia, PA (US)

Correspondence Address: Vincent R. Fedele, 12064 ABBY RD, Philadelphia, PA, 19154, US

(21) Appl. No.: 09/874,583

(22) Filed: Jun. 5, 2001

Related U.S. Application Data
(60) Provisional application No. 60/209,362, filed on Jun. 5, 2000.

(51) Int. Cl. B32B 3/00; B32B 27/14

(52) U.S. Cl. 428/195; 428/220; 428/904.4; 428/48

(57) ABSTRACT

a 6 mil thick 42″ wide weather resistant sheeting that is stapled or glued on top of the boards that are used to seal a building when vacancy, fire or condemnation occurs.

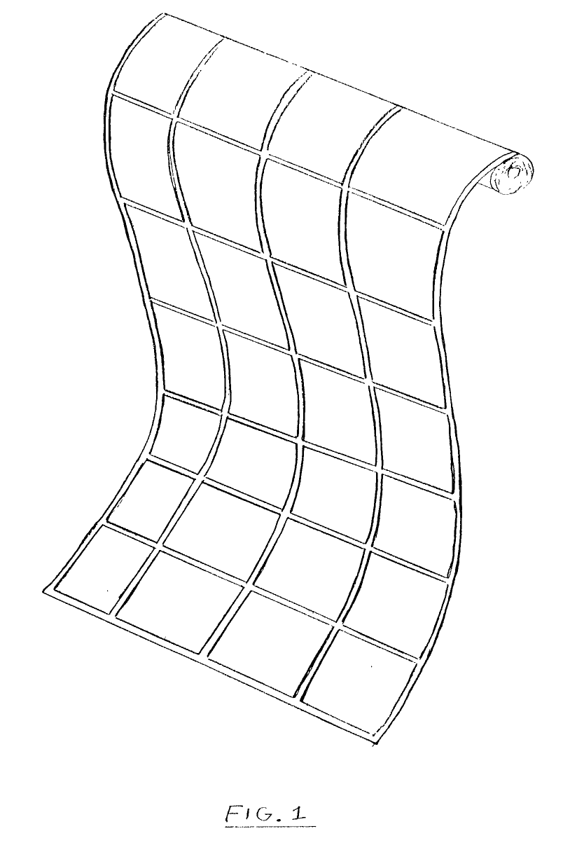

Once this window grid like sheeting is applied to all boards, the building will then have the false look of windows, removing the ugly sight and vacant look.

There are ½″ thick white lines spaced evenly thoughout the roll of sheeting over top of a black background. This grid duplicated the look of small window panes or muttons of a window.

This RPA is a follow up for the PPA No. 60/209,362, filing date Jun. 5, 2000

### BACKGROUND

1. Field of Invention

This invention relates to the aesthetic solution to make condemned buildings look like their not condemned.

2. Discussion of Prior Art

When buildings become boarded-up due to either fire, vacancy, condemnation, etc . . . the sight is not very pleasant.

Some solutions to rid or lessen the ugly sight were to paint the boards. This process can be time consuming

Window Dressing is an efficient way of covering the boards to rid the condemned look of a building. Just cut it to size and staple or glue onto the boards.

### OBJECTS AND ADVANTAGES

Accordingly here are some of the advantages of Window Dressing.

a. a quick aesthetic solution to covering the ugly sight of boarded buildings

b. a grid like pattern on the viewed side to provide the look of a window.

### DRAWING FIGURES

In the drawing, the continuous roll is 42″ wide. The viewed side has ½″ white grids over top of a black background to provide the look (when applied on top of the boards) of a window.

The covering is a 6 mil thick plastic sheeting with Ultraviolet additives to provide resistant against the Sun's rays.

### DESCRIPTION

The plastic sheeting is 6 mil thick and 42″ wide. It is cut to size with a utility knife or scissors. It is then stapled or glued over top of the boards that have been placed in the windows to provide a look of a window. Once these sheets are placed on top of all boards, the building will then look like it has windows and is not condemned.

1. An article of sheeting for covering the boards used to seal condemned buildings:
a). a sheet of thin flexible material that is applied to cover the boards used to seal up condemned buildings.
b). said material should be weather resistant and easy to cut and apply.
